(19) United States
(12) Patent Application Publication
(10) Pub. No.: US 2007/0007018 A1
(43) Pub. Date: Jan. 11, 2007

(54) Sprinkler system with plastic piping

(76) Inventor: Yun Chung Kong, Toronto (CA)

Correspondence Address: DAVID W. WONG, 46 WILLOWBROOK ROAD, THORNHILL, ON, L3T 4W9, CA

(21) Appl. No.: 11/177,978

(22) Filed: Jul. 11, 2005

(51) Int. Cl. A62C 35/00; A62C 37/08

(52) U.S. Cl. 169/16; 169/5; 169/17; 169/37

(57) ABSTRACT

A two-stage hydraulic pressure fire protection sprinkler piping system includes a metal pipe section and a plastic pipe section. The metal pipe section may be connected to a high pressure water supply source while the plastic pipe section delivers water of a predetermined pressure level to spray sprinkler heads to provide a selected fire extinguish water spray pattern in a floor area of a multi-storey building. The high pressure in the metal pipe section is reduced to the predetermined level by a pressure reducing valve connected between the metal pipe section and the plastic pipe section to prevent occurrence of distorted water spraying pattern and pre-matured strain aging of the plastic material of the plastic pipe section.

### BACKGROUND OF THE INVENTION

1. Field of the Invention

This invention relates to a fire protection sprinkler system and more specifically to a sprinkler system having plastic sprinkler piping components.

2. Background Art

There are many utility systems in modern buildings, such as HVAC (heating, ventilation & air conditioning) system; electrical power and communication system; structural system; and fire protection system. All these systems must comply with various engineering codes and standards which are integrated into one another in order to ensure that all buildings comply fully with modern building and urban development safety requirements. Moreover, the standards also extend into the application of fire fighter's truck performance standards under the fire safety code of all regional government jurisdictions. NFPA (National Fire Protection Association) standards are adopted by the U.S., Canada and many other countries throughout the world for regulating the fire protection practices. Among the NFPA standards, the NFPA-13 standard provides the requirements for the installation of fire protection sprinkler system for buildings for a floor area of up to 52000 ft²/floor system. Additionally, NFPA 1901 Standard for Automotive Fire Apparatus; NFPA 1912 Fire Apparatus Refurbishing; and NFPA 20 standard for intallation of stationary pumps govern the minimum safety requirements of the design of a fire protection sprinkler system. The engineering principle in fire protection in these standards is adopted world wide.

One of the safety criteria for sprinkler systems is the requirement of providing a fire department connection, commonly known as Siamese connection for the system. In the event of fire, fire trucks with water pumps installed to NFPA-1912 and NFPA-1901 standards may be required to connect to the Siamese connection. The water pumps will be pumping water into the sprinkler system through the Siamese connection at a minimum rated capacity of 250 gpm (or 946 L/min) at 150 psi (or 1035 kPa). The maximum water pressure to be exerted into the sprinkler system could be as high as 250 psi (or 1725 kPa). For high rise buildings, where the public water pressure is unable to deliver the required amount of water to high level floors, stationary water pumps installed to NFPA 20 standard must be employed to boost the water pressure for the sprinkler systems in the building and/or in addition to the water pumps from the fire trucks. The performance capacity of these stationary water pumps is similar to water pumps equipped on the fire trucks.

Components made of steel and/or other metal material are traditionally employed for constructing a sprinkler system. The hydraulic calculation for such sprinkler system is a single stage calculation without having to consider the stress to strain restriction of the material used in the components since steel and similar metals have a high stress and strain ratio and they can withstand very high hydraulic pressure; and they will hardly elongate, yield and deform when under stress. The hydraulic calculation merely requires to evaluate the hydraulic pressure at the sprinkler head of the most critical floor level to the city water supply source.

NFPA standards, particularly the NFPA 13-1.6 New Technology standard, permit the use of new materials and technologies in sprinkler systems. Thus, plastic pipes have been considered for such application since plastic pipes have a smoother surface than steel pipes so that they provide less flow friction to the water flowing therethrough, and smaller pipe size may be designed to deliver the same amount of water required. However, there are two major technical problems in the application of plastic piping for sprinkler systems, namely:
1. Deformation and twisting of the pipes under excessive high pressures generated from booster fire water pump; and
2. Pre-matured strain aging of plastic under excessive high pressure generated from booster fire water pumps.

Plastic water pipes are commonly made of PVC, CPVC and PB materials which have a low stress to strain ratio. Thus, under high pressure of over 100 psi normally exerted by fire water pumps will inherently cause severe twisting of components made of such plastic materials in a sprinkler system so as to distort the orientation of the water spraying pattern required by the NFPA 13 standard. This detrimental phenomenon is more worse when smaller size plastic pipes are employed. For sprinkler systems of a large area, the phenomenon of accumulated twisting of pipes becomes even worse in causing damages for plastic sprinkler piping sections located on the lower floors which are close to the fire water pumps. For these reasons, it has not been possible to design a plastic sprinkler system to meet the requirement of the NFPA 13 standard of 52000 ft²/floor system.

### SUMMARY OF THE INVENTION

It is a principal object of the present invention to provide a two-stage hydraulic system with a sprinkler system employing plastic piping.

It is another object of the present invention to provide a sprinkler system which meets all the requirements of the NFPA standard.

It is another object of the present invention to provide a plastic sprinkler system which is safe to be connected to the booster fire water pumps of fire trucks in the event of fire.

It is still another object of the present invention to provide a plastic sprinkler system which is not subject to pre-matured strain aging.

### BRIEF DESCRIPTION OF THE DRAWINGS

FIG. 1 is an overall schematic diagram of the sprinkler system according to the present invention.

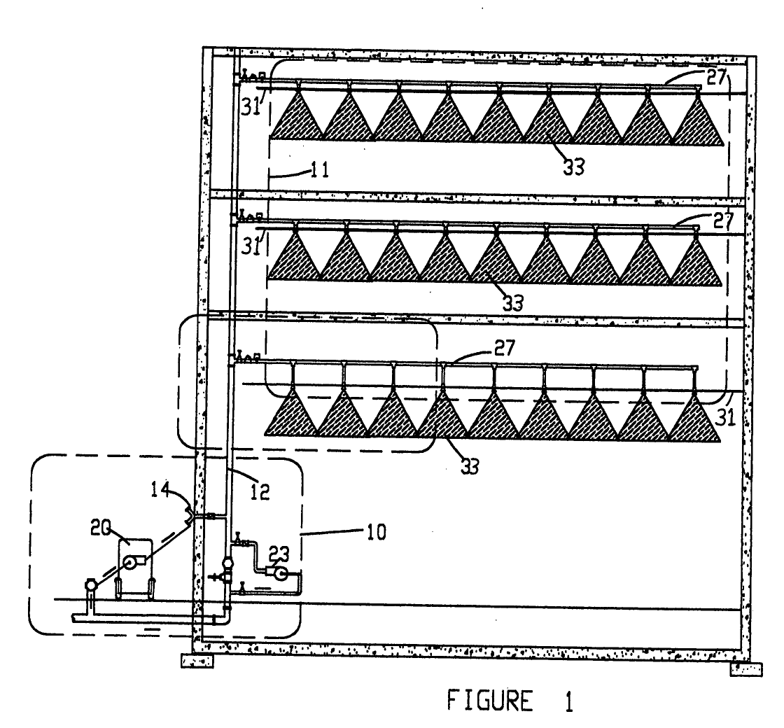

FIG. 2 is an enlarged schematic diagram of the high pressure section of the sprinkler system according to the present invention.

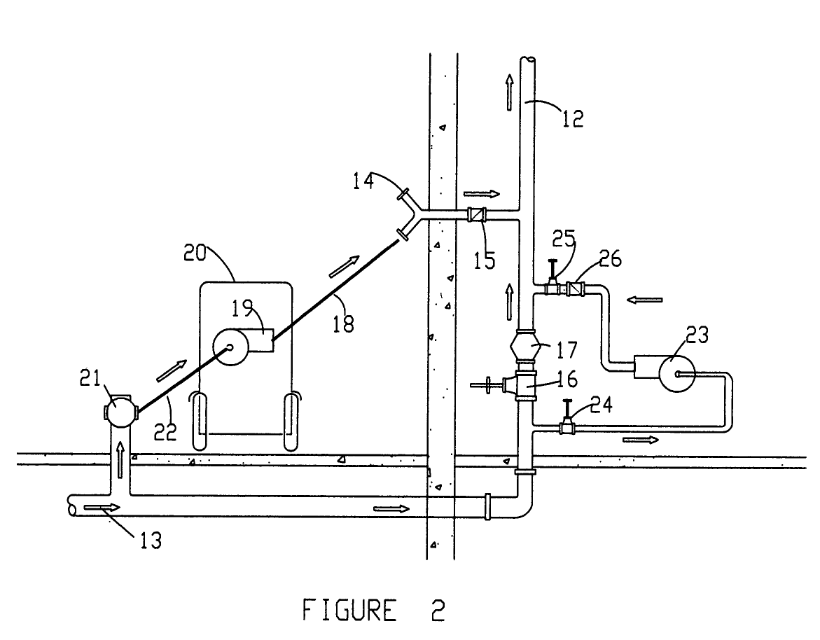

FIG. 3 is an enlarged schematic diagram of the plastic piping section of the sprinkler system according to the present invention.

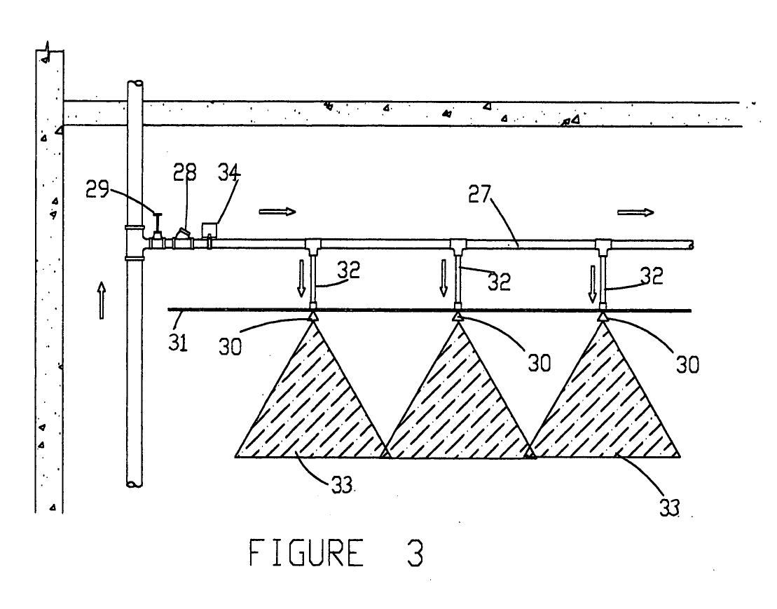

### DETAILED DESCRIPTION OF THE PREFERRED EMBODIMENTS

With reference to the drawings, the sprinkler system according to the present invention generally has two main sections, namely a high pressure section 10 and a lower pressure section 11. The high pressure section 10 includes a steel or metal riser 12 for connection to city water supply 13, and a fire department connection, namely the siamese connection 14. A check valve 15 is provided between the siamese connection 14 and the steel riser 12 to prevent water from the steel riser 12 to escape from the sprinkler system under normal condition. A main shut off valve 16 and an alarm check valve 17 are provided at the connection to the city water supply 13 in order that the city water supply 13 may be shut off from the high pressure section 10 if required such as for maintenance services and for preventing water in pipe section 12 from back flow to the city water supply 13. The siamese connection 14 is for connecting to the water hose 18 from the fire water pump 19 of the fire truck 20 in the event of fire such that the water supply from a fire hydrant 21 connected to the fire water pump 19 by connecting hose 22 may be boosted to a high pressure of 250 psi (or 1725 kPa) in order to maintain the water pressure supply to fire extinguishing sprinklers in all floor levels in a building while the fire truck is pumping city water 13 from the fire hydrant 21 for fire fighting outside of the building by fire fighters. The high water pressure may also be supplied to the steel riser 12 by a stationary bypass installed in the building which consists of a stationary fire pump 23 connected between the city water supply 13 and the steel riser 12. The stationary bypass is normally opened from the steel riser 12 by shut off valves 24 and 25. The shut off valves 24 and 25 and other additional shut off valves which may be provided, are for maintenance services only such that they may be turned off if required. An additional check valve 26 is located between the shut off valve 25 and the stationary fire pump 23 to prevent high pressure water from the steel riser 12 from entering the stationary bypass when the shut off valve 25 is inadvertently left open. Since all components in the high pressure section 10 are made of steel or similar metal its design and calculation consideration are fully in compliance with the requirements of the NFPA standards.

The pressure monitored section of the sprinkler system of the present invention comprises of similar sprinkler piping for all floor levels in the building. All piping components are made of plastic material in order to provide desirable low friction water flow. Each horizontal sprinkler water supply cross main pipe 27 on each floor of the building is connected to the steel riser 12 through a pressure reducing valve 28 which regulates the water pressure flowing into the sprinkler piping to under 75 psi. A shut off valve 29 is provided between the pressure reducing valve 28 and the connection to the steel riser 12 so that water supply to the sprinkler piping in each floor may be shut off if required. The lower friction surface of the plastic piping facilitates the water to flow efficiently through the plastic piping including the network of branch lines (not shown) connected to the main pipe 27 and covering over the entire floor area up to 52,000 ft². The spray sprinkler heads 30 extending just below the suspended ceiling 31 of each floor are connected to the main pipe 27 and the branch lines by vertical connection pipes 32. The spray sprinkler heads 30 are provided with heat sensing control in the normal manner such that in the event of fire the spray sprinkler head 30 will automatically open to provide the water spray for extinguishing the fire. Due to the efficient water flow in the sprinkler piping, the water spray pattern 33 will comply with the requirements of the NFPA standards. The pressure reducing valve 28 in each sprinkler piping section of each floor thus maintains a desirable water pressure to 75 psi or less so as to prevent twisting and distortion of the water spray pattern 33 when the sprinkler system is connected to the high pressure fire water pump 19 or the stationary fire pump 23. A water flow switch 34 is provided between the pressure reducing valve 28 and the main pipe 27 such that the water flow to the main pipe 27 will be monitored.

The design of the sprinkler system of the present invention may be achieved by a two-stage hydraulic calculation model. Stage one of the hydraulic calculation model is to determined the pipe sizes of the plastic piping section to meet the required amount of water flow and pressure in order to comply with the engineering and standards requirements as well as to prevent distortion and twisting of the plastic piping material. The calculation is based on the flow performance specification and a maximum water pressure of up to 75 psi. The stage two of the hydraulic calculation model is to determine the pipe sizes of the steel piping section required to supply the amount of water flow and pressure to meet the demand of the rigid plastic piping section. The calculation demand data will be based on the results of the stage one hydraulic calculation of the flow volume and pressure data. The maximum water pressure allowed for this section shall be based on the full strength capacity of the steel pipes and the standards of regional authority having the jurisdiction in regulating the pressures of the public water main supply and the fire pumps.

Excessive water pressure from the steel piping section to the plastic piping section on each floor of the building will be reduced by pressure reducing valves 28 to 75 psi or less as determined by the stage one calculation. Selection of the pressure reducing valve 28 shall be determined by the two sets of calculation information from both stages. The stage one hydraulic data will be used as an out flow requirement of the pressure reducing valve 28, while the hydraulic data from stage two will be used to determine the inlet side of the pressure reducing valve 28.

It will be understood by those skilled in the art that, while this invention has been described with reference to preferred embodiments, various changes may be made without departing from the scope of the invention. Therefore, it is intended that the invention not be limited to the particular embodiments disclosed as the best modes contemplated for carrying out this invention, but that the invention will include all embodiments falling within the scope of the claims that follow.

What is claimed is:

1. A sprinkler system for a building comprising:
a metal piping section adapted for connection to a high pressure water supply source,
a plastic piping section connected to said metal piping section and adapted to deliver water to spray sprinkler heads provided on each floor of said building,
a pressure reducing valve connected between said metal piping section and said plastic piping section operative for reducing high water pressure of said high pressure water supply source to a predetermined level in said plastic piping section.

2. A sprinkler system according to claim 1 wherein said metal piping section includes a metal riser pipe extending vertically throughout the entirety of said building for connection to said plastic piping section located on all floors, said metal riser pipe is connected to a public water supply.

3. A sprinkler system according to claim 2 including an external connection coupled to said riser pipe and operative for connection to a high pressure water supply source external to said sprinkler system for supplying a high pressure water supply to said sprinkler system.

4. A sprinkler system according to claim 3 including a check valve connected between said external connection and said riser pipe and operative for preventing water from said riser pipe to escape from said external connection when said external connection is not connected to said high pressure water supply source.

5. A sprinkler system according to claim 4 wherein said high pressure water supply source is a high pressure booster water pump in a fire truck.

6. A sprinkler system according to claim 4 wherein said high pressure water supply source is high pressure booster stationary fire water pump located in said building,

7. A sprinkler system according to claim 4 wherein said plastic piping section includes a main plastic pipe in each floor of said building and connected to said riser pipe, and a network of plastic branch pipes connected to said main plastic pipe and extending over the entirety of a predetermined floor area of said floor, a plurality of spray heads connected to said main plastic pipe and said plastic branch pipes and operative for providing a predetermined fire extinguishing water spray pattern of water for said floor area.

8. A sprinkler system according to claim 7 including a shut off valve and a water flow switch connected between said riser pipe and said main plastic pipe, said shut off valve being operative for shutting water supply to said plastic piping section, said water flow switch being operative for monitoring water flowing from said riser pipe to said main plastic pipe.

9. A sprinkler system according to claim 8 including a main shut off valve provided on said riser pipe and operative for shutting said public water supply from said sprinkler system.

10. A sprinkler system for a building having a plurality of floor levels, comprising:
a metal riser pipe extending vertically throughout the entirety of said building for supplying fire extinguishing water to said floor levels,
an external water supply connection provided on said metal riser pipe and adapted for connecting a high pressure water supply source to said riser pipe,
a plurality of main plastic pipes located in each floor of said floor levels and connected to said metal riser pipe,
a pressure reducing valve connected between each one of said main plastic pipes and said riser pipe and adapted to reduce water pressure of water flowing into said main plastic pipes from said main plastic pipes to a predetermined level,
a network of plastic branch pipes connected to said main plastic pipes and extending over a predetermined floor area of said floor levels,
a plurality of sprinkler spray heads connected to said plastic main pipes and said plastic branch pipes and operative for spraying fire extinguishing water of a predetermined pattern onto said floor area of said floor levels in case of fire.

11. A sprinkler system according to claim 10 wherein said riser pipe is a steel pipe having a high strain to stress ratio and is connected to a public water supply.

12. A sprinkler system according to claim 11 including an auxiliary shut off valve located between each of said main plastic pipe and said riser pipe operative for shutting water supply to said main plastic pipe in a selected floor level, and a water flow switch connected between said main plastic pipe and said riser pipe and operative for monitoring water flow from said riser pipe to said main plastic pipe.

13. A sprinkler system according to claim 12 including an additional stationary fire water pump located in said building and operative to boost water supply pressure in said riser pipe to a predetermined high pressure level.
